(19) United States
(12) Patent Application Publication
(10) Pub. No.: US 2024/0111459 A1
(43) Pub. Date: Apr. 4, 2024

(54) STORAGE COMMAND COMPRISING TIME PARAMETER

(71) Applicant: Intel Corporation, Santa Clara, CA (US)

(72) Inventors: Daniel Christian Biederman, Saratoga, CA (US); Jackson L. Ellis, Fort Collins, CO (US)

(73) Assignee: Intel Corporation, Santa Clara, CA (US)

(21) Appl. No.: 18/532,491

(22) Filed: Dec. 7, 2023

(51) Int. Cl. G06F 3/06

(52) U.S. Cl. CPC G06F 3/0659; G06F 3/0679; G06F 3/0604

(57) ABSTRACT

An apparatus comprising first circuitry to determine a time parameter associated with a storage operation; and second circuitry to generate a storage command, the storage command including the time parameter, a location for the storage operation, and an opcode specifying the storage operation.

### BACKGROUND

A computing system may comprise a storage device comprising memory that may be accessed by a consuming device, such as a processing unit. The memory may be accessed using storage commands.

### BRIEF DESCRIPTION OF THE DRAWINGS

FIG. 1 illustrates an example computing environment in which a storage command comprising a time parameter may be used.

FIG. 2 illustrates another example computing environment in which a storage command comprising a time parameter may be used.

FIG. 3 illustrates an example storage command comprising a time parameter.

FIG. 4 illustrates a flow for executing storage commands comprising time parameters.

FIG. 5 illustrates a flow for generating a storage command comprising a time parameter.

FIG. 6 illustrates an example computing system that may generate or execute a storage command comprising a time parameter.

Like reference numbers and designations in the various drawings indicate like elements.

### DETAILED DESCRIPTION

Memory access may be a very expensive part of any computational system. In certain memory protocols, a memory removal command (e.g., a deallocation command such as TRIM or similar commands) may provide the ability to remove large areas of memory (e.g., in a storage drive, such as a solid state drive (SSD)) quickly. In certain memory devices (e.g., SSDs), a memory removal command may cause a memory block to be marked as invalid and then erased by the drive as needed. The memory block may then be reused. However, in some instances, problems may arise if memory removal commands are processed out of order with subsequently sent write commands or are otherwise not processed at the correct time.

Memory may be required to store data as the data arrives for processing. When the data arrives at a speed that is different from the speed at which the data is consumed (e.g., due to jitter that occurs in the network), the data may underflow (an accelerator may be ready for data that has not yet arrived) or overflow (data may arrive for a processing unit that is not ready for the data and may be placed in excess memory until the processing unit is ready).

Various approaches may be taken to mitigate this issue. For example, some systems may pace video data so that the traffic arrives at the processor at the processor's consumption rate. For example, if the video runs at 60 frames per second, then the data may be paced such that one frame arrives every 1/60th of a second with some margin. In other systems, memory may be over provisioned to allow for overflow conditions (e.g., due to network jitter). However, overprovisioning may be expensive, consume more power, and result in larger area of the system.

In various embodiments of the present disclosure, a storage protocol may utilize one or more storage commands that includes at least one time parameter, such as a time or rate. The time parameter may be associated with the performance of a storage operation specified by the storage command. For an example, a storage command may specify that a storage removal operation (e.g., a deallocation) or a flush operation should occur at a precise time. As another example, a storage command that requests data to be read from a storage drive (e.g., a remote storage drive) may specify that the data is to be sent (or is to arrive) at a precise time or at a precise rate.

A storage command may specify multiple storage operations and may include a time parameter for one of the operations. For example, a write or read command may specify that the target data may be removed (e.g., deallocated, marked invalid, erased, etc.) at a precise time. In some embodiments, a storage command may include multiple time parameters where a respective time parameter corresponds to one storage operations of multiple storage operations specified by the storage command.

Various embodiments may enable a just-in-time storage concept, where data arrives at the time that it is needed for processing. This may significantly reduce the memory required at processing units (e.g., accelerators) by only requiring storage for the just-in-time data.

Embodiments that allow for proactive communication to a storage device as to when to invalidate data may result in avoidance of jitter in the command's execution due to communication issues (e.g., dropped packets, large latencies, random latencies, etc.). For example, a network may have communication issues wherein small packets carrying storage commands specifying removal of data are deprioritized behind larger packets, resulting in increased latency and potential issues. For example, a write command that is sent after a removal command could be executed before the removal command, resulting in undesired operation if the memory is not erased before the write command is performed and/or the erase occurs after the write operation. As another example, if memory space is limited, the storage device may evict or overwrite data that should not have been evicted or overwritten. In embodiments herein, the storage command specifying removal of data may be sent ahead of time in a separate command or in a command specifying another storage operation (such as a write or read), and thus potential latencies for such operations or other problematic issues may be avoided.

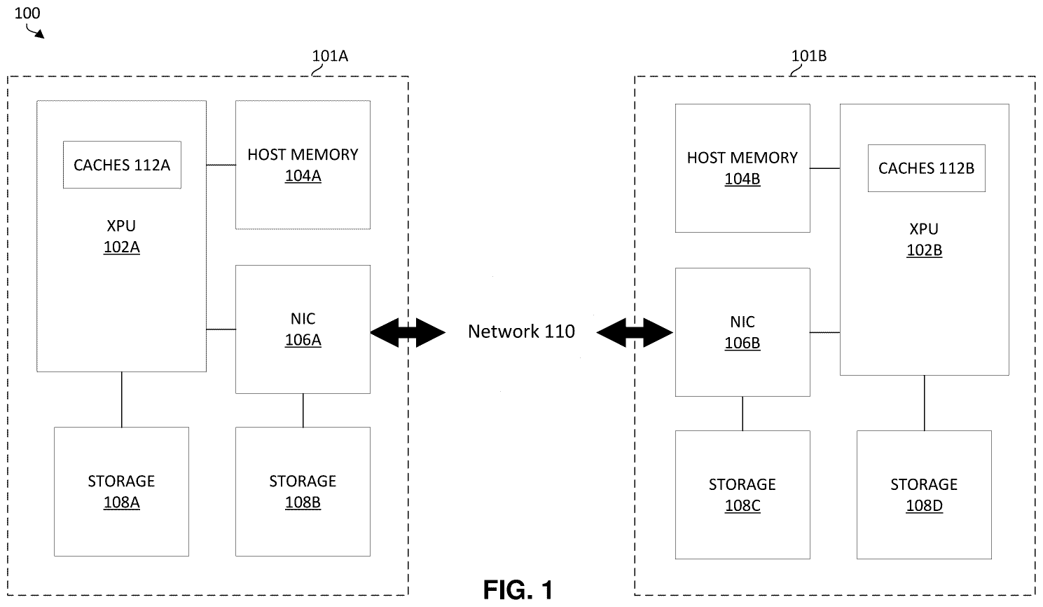

FIG. 1 illustrates an example computing environment 100 in which a storage command comprising a time parameter may be used. Computing environment 100 includes a first computing system 101A and a second computing system 101B coupled together via network 110. The computing systems 101A and 101B are shown as having the same components, though in other embodiments computing systems coupled together may include any suitable arrangement of computing components.

Computing system 101A includes a processing unit (XPU) 102A, a host memory 104A, network interface controller (NIC) 106A, and storage drives 108A and 108B. Host memory 104A, NIC 106A, and storage drive 108A are directly connected to the XPU 102A, while storage drive 108B is coupled to the XPU 102A via NIC 106A. Computing system 101B includes a similar arrangement (while in other embodiments computing systems coupled together may each include any suitable arrangement of computing components).

The storage command may be generated by a requesting device (which may include circuitry to determine a time parameter and circuitry to generate a storage command) and be sent to a target device (which may include memory and circuitry such as a controller to decode and process the storage command). Data returned by a storage device may be consumed (e.g., processed) by a consuming device, which may be the same device as the requesting device or may be a different device.

A storage command may be communicated to and/or may be performed by any suitable storage device that includes addressable memory. For example, such devices may include storage drives (such as solid state drives with flash memory, hard disk drives, etc.); storage appliances; host memory (e.g., that stores data for applications being run by an XPU, host memory may be DRAM or other volatile memory in some instances); caches (e.g., an L1 cache, an L2 cache, a last level cache, other specialized cache, etc.); a first in first out (FIFO) structure within a cache; a scratch pad memory within a cache; a memory card; a Universal Serial Bus (USB) drive; a Dual In-line Memory Module (DIMM), such as a Non-Volatile DIMM (NVDIMM); storage integrated within a device such as a smartphone, camera, or media player; or other suitable storage device. In various embodiments, the storage device may be used in any suitable configuration such as memory pooling, two-level memory (2LM), multi-tiered memory, Compute Express Link (CXL) attached, multi-tenant, and scalable I/O virtualization (e.g., Scalable IOV) environments.

The memory of a storage device may comprise non-volatile memory and/or volatile memory. Non-volatile memory is a storage medium that does not require power to maintain the state of data stored by the medium, thus non-volatile memory may have a determinate state even if power is interrupted to the device housing the memory. Nonlimiting examples of nonvolatile memory may include any or a combination of: 3D crosspoint memory, phase change memory (e.g., memory that uses a chalcogenide glass phase change material in the memory cells), ferroelectric memory, silicon-oxide-nitride-oxide-silicon (SONOS) memory, polymer memory (e.g., ferroelectric polymer memory), ferroelectric transistor random access memory (Fe-TRAM) ovonic memory, anti-ferroelectric memory, nanowire memory, electrically erasable programmable read-only memory (EEPROM), a memristor, single or multi-level phase change memory (PCM), Spin Hall Effect Magnetic RAM (SHE-MRAM), and Spin Transfer Torque Magnetic RAM (STTRAM), a resistive memory, magnetoresistive random access memory (MRAM) memory that incorporates memristor technology, resistive memory including the metal oxide base, the oxygen vacancy base and the conductive bridge Random Access Memory (CB-RAM), a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory.

Volatile memory is a storage medium that requires power to maintain the state of data stored by the medium (thus volatile memory is memory whose state (and therefore the data stored on it) is indeterminate if power is interrupted to the device housing the memory). Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (double data rate version 3, original release by JEDEC (Joint Electronic Device Engineering Council) on Jun. 27, 2007, currently on release 21), DDR4 (DDR version 4, JESD79-4 initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5, originally published by JEDEC in January 2020, HBM2 (HBM version 2), originally published by JEDEC in January 2020, or others or combinations of memory technologies, and technologies based on derivatives or extensions of such specifications.

In various embodiments, components of computing environment 100 (including requesting, target, and/or consuming devices) may be coupled together through one or more networks (e.g., network 110) comprising any number of intervening network nodes, such as routers, switches, or other computing devices. The network 110, the requesting device, and/or the target device may be part of any suitable network topography, such as a data center network, a wide area network, a local area network, an edge network, or an enterprise network.

The storage command may be communicated from the requesting device to the target device and/or data read responsive to a storage command may be communicated from the target device to the consuming device over any suitable communication protocol (or multiple protocols), such as peripheral component interconnect (PCI), PCI Express (PCIe), CXL, Universal Serial Bus (USB), Serial Attached SCSI (SAS), Serial ATA (SATA), InfiniBand, Fibre Channel (FC), IEEE 802.3, IEEE 802.11, Ultra Ethernet, or other current or future signaling protocol.

In particular embodiments, the storage commands conform with a logical device interface specification such as Non-Volatile Memory Express (NVMe) (e.g., as described by one or more of the specifications available at www.nvmexpress.org/specifications/) or Advanced Host Controller Interface (AHCI) (e.g., as described by one or more AHCI specifications such as Serial ATA AHCI: Specification, Rev. 1.3.1 available at http://www.intel.com/content/www/us/en/io/serial-ata/serial-ata-ahci-spec-rev1-3-1.html.

A computing platform may include one or more requesting devices, consuming devices, and/or target devices. Such devices may comprise one or more processing units (e.g., processing units 102) to generate a storage command, decode and process a storage command, and/or consume (e.g., process) data requested by a storage command. As used herein, the terms “processor unit”, “processing unit” or “processor” may refer to any device or portion of a device that processes electronic data from registers and/or memory to transform that electronic data into other electronic data that may be stored in registers and/or memory. A processing unit may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), edge processing units (EPUs), vector processing units, software defined processing units, video processing units, data processor units (DPUs), memory processing units, storage processing units, accelerators (e.g., graphics accelerator, compression accelerator, artificial intelligence accelerator, networking accelerator), controller cryptoprocessors (specialized processors that execute cryptographic algorithms within hardware), server processors, I/O controllers, NICs (e.g., SmartNICs), infrastructure processing units (IPUs), microcode engines, memory controllers (e.g., cache controllers, host memory controllers, DRAM controllers, SSD controllers, hard disk drive (HDD) controllers, non-volatile memory controllers, etc.), or any other suitable type of processor units. As such, a processor unit may be referred to as an XPU.

Although not depicted, system 101A (or other computing system described herein) may use a battery and/or power supply outlet connector and associated system to receive power, a display to output data provided by XPU 102A, or a network interface allowing the XPU 102A to communicate over a network (e.g., network 110). In various embodiments, the battery, power supply outlet connector, display, and/or network interface may be communicatively coupled to XPU 102A. Other sources of power can be used such as renewable energy (e.g., solar power or motion based power).

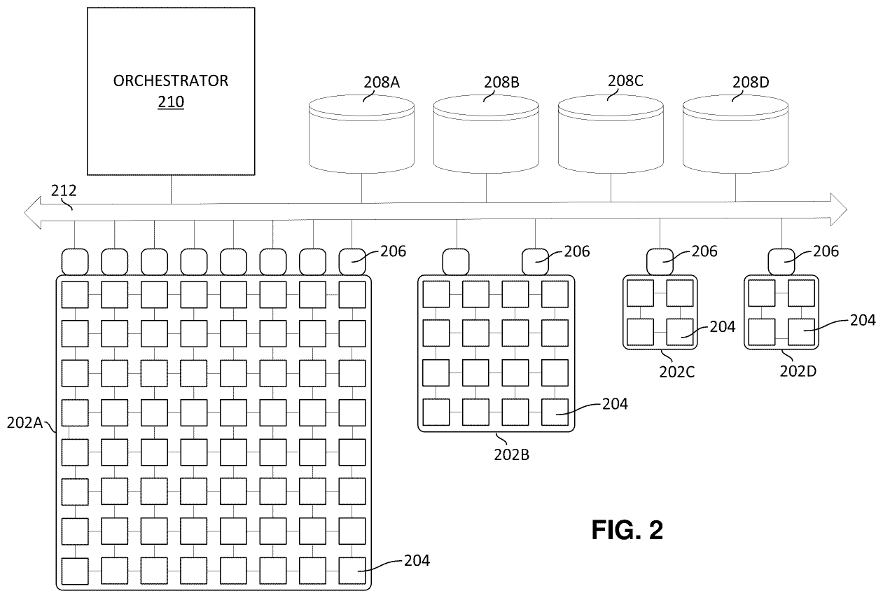

FIG. 2 illustrates another example computing environment 200 in which a storage command comprising a time parameter may be used. Environment 200 may include various clusters (e.g., 202A-D) of processing units 204 (e.g., GPUs, Tensor Flow processors, other types of accelerators, etc.). A cluster 202 may also include one or more IPUs 206 to facilitate communication between the processing units 204 and network 212. Network 212 may further be coupled to various storage devices 208A-D and orchestrator 210. Components of environment 200 may have any suitable characteristics of similar components of environment 100. For example, environment 200 may be, e.g., an Ethernet, Ultra Ethernet, CXL, a network using a proprietary network protocol, or other suitable network.

In some embodiments, computing environment 200 may be a data center or other similar environment, where any combination of the components may be placed together in a rack or shared in a data center pod. In various embodiments, computing environment 200 may represent a telecom environment, in which any combination of the components may be enclosed together in curb/street furniture or an enterprise wiring closet.

In some embodiments, orchestrator 210 may function as a requesting device and send storage commands comprising time parameters as described herein to storage devices 208A-D functioning as target devices. Some of these commands may read data that is then supplied to processing units 204 that are functioning as consuming devices. In some embodiments, a processing unit 204 or an IPU 206 may function as the requesting device. Thus, a processing unit 204 could be both a requesting device and the consuming device.

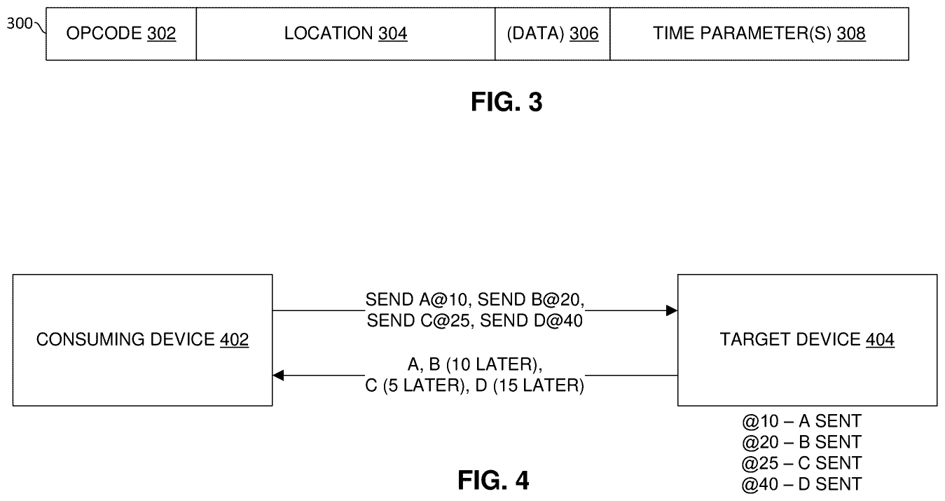

FIG. 3 illustrates an example storage command 300 comprising one or more time parameters 308. In this example, the storage command 300 includes an opcode 302, a location 304, and one or more time parameters 308. Some storage commands 300 (e.g., commands specifying a write operation) may also include data 306 (or a reference to data) to be written.

A time parameter 308 included in a storage command may be any suitable parameter that instructs the timing of all or a portion of the execution of one or more operations specified by the storage command.

As an example, the time parameter may be a time that a storage operation is to be performed. The time may expressed in any suitable manner, such as an actual time (e.g., 10:30:15, 21:45:00) or an amount of time (e.g., 15 milliseconds, 100 microseconds, 1 minutes, etc.) expressed relative to an event. Examples of relative times include an amount of time after the storage command is sent, an amount of time after the storage command is received, an amount of time after an operation (e.g., a read, write, transfer of data, erasure, deallocation, flush, etc.) specified by the storage command is performed, or other suitable latency relative to another event.

As another example, a time parameter may be a time range, for example, a window of time during which data is valid and outside of which data is not valid.

In some embodiments, a time parameter may be a precise time. In a data center or other computing environment, various components (e.g., IPUs, servers, accelerators, etc.) may keep times that are precisely aligned in a precise time domain. The components may utilize any suitable scheme for distributing and synchronizing precise times, such as IEEE 1588, PCIe's precise time measurement (PTM), a pulse per second (e.g., as used in telecom), a 10 kHz clock pulse, or other suitable method.

In various embodiments, a time parameter may be or be based on an accurate time. For example, the accurate time may be a time according to the UTC that is within a small margin of error of the UTC time.

As another example, the time parameter may specify a rate, such as a rate of data transmission or a rate of data consumption. In some embodiments, a time parameter specifying a delivery time and an amount of data specified by a storage command may be used by the target of the storage command to calculate a rate of transmission or consumption.

As another example, the time parameter may specify an end time of an operation associated with the storage command. As one example, the end time may specify a deadline for performance of an operation (e.g., because data will no longer be valid after the end time). As another example, the time parameter may specify an end time until which packets from a data transfer (e.g., resulting from a read command) are to be coalesced (e.g., combined). Coalescing may take place at either the consuming device or a device before the consuming device (e.g., a NIC or IPU). it. For example, a NIC or IPU may coalesce data up to the end time and then transfer it to a CPU's memory (e.g., cache, DDIO area of a cache, host memory, etc.).

Storage command 300 may also comprise an opcode 302. The opcode 302 may be a representation (e.g., a numerical representation such as a binary representation) of one or more storage operations. For example, in various storage commands a unique opcode may correspond to a write, read, flush, storage removal (e.g., erase, deallocate, invalidate, etc.), or in-memory compute (e.g., specifying an arithmetic or logical operation) operation. In some examples, a unique opcode may correspond to multiple storage operations, such as read and deallocate, write and deallocate, read and erase, write and erase, write and flush, in-memory compute and read and erase, or any other combination of commands described herein or other suitable storage commands. When an opcode specifies two (or more) operations, the storage command may include a time parameter paired with one of the operations or that is associated with both (or all) of the operations. In some embodiments, a storage command may include a first time parameter for a first operation and a second time parameter for a second operation specified by the opcode (and so on if additional operations are specified). In some embodiments, a storage command may include multiple time parameters for an operation specified by the opcode. For example, a read storage command may include a rate and an arrival time deadline.

In some examples, an endpoint may know a time for a group to be transferred to the CPU memory, thus it could transfer a group number instead of an explicit time, as the required time for that group number is known by the endpoint. A simple case for this involves a ping buffer group and a pong buffer group (where the group number could be represented by a single bit). A single storage command (e.g., an NVMe command) could provide the transfer time for the group (or time for a storage removal, flush operation, or other storage operation).

Storage command 300 may also include a location 304. A location may identify a memory range of one or more memory addresses in the memory of the target device that identifies a target for one or more operations specified by the storage command. The location may be specified in any suitable manner, such as a single address, an address plus an offset, a first address (e.g., a start address) and a second address (e.g., an end address), or other suitable manner. The location may be any suitable memory unit such as a memory block (e.g., a non-volatile memory block, such as a flash block), a cacheline, etc. In various embodiments, the location may refer to memory of short term memory (e.g., DRAM), long term memory (e.g., a storage drive), or other suitable memory.

In embodiments where a storage command specifies a write command (e.g., the opcode of the storage command may correspond to a write operation), the storage command may specify a location and data (or a reference to the data) to be written to the location. The storage command may also include a time parameter (or multiple time parameters) that specifies one or more of the following: a time at which the data should be written, a time delay after which the data should be written, or a rate at which the data should be written.

In embodiments where a storage command specifies a read command (e.g., the opcode of the storage command may correspond to a read operation), the storage command may include a location from which data is to be read. The storage command may also include a time parameter (or multiple time parameters) that specify one or more of the following: a time at which the data should be read by the target device, a time at which the data should begin being transferred from the target device to the consuming device, a time by which the data should finish being transferred from the target device, a time at which or by which the data should begin or finish arriving at the consuming device, a time delay after which the data should be read, transferred, or arrive at the consuming device, a rate at which the data should be transferred by the target device to the consuming device, a rate at which the data is to be consumed by the consuming device, or other suitable time parameter.

In one particular example, it is known that one or more processing units need data at a specified time. The consuming device of the read storage command may know its expected consumption rate as well as when the data is needed by. The consuming device (or another requesting device on its behalf) may then send a storage command to the target device including a time parameter specifying the time it would like to receive the data or the time it would like the target device to send the data. Such consumer designed pacing may utilize information about the computing environment of the consumer to reduce the need for overprovisioning the memory for overflow conditions.

FIG. 4 depicts a flow for using storage commands with time parameters to schedule the transfer of data read from a target device. In this embodiment, a consumer device 402 sends a series of read commands to the target device 404. In some embodiments, the read commands could be NVMe or NVMeoF read commands.

A first read command includes a time parameter specifying that data A is to be sent at time 10, a second read command includes a time parameter specifying that data B is to be sent at time 20, a third read command includes a time parameter specifying that data C is to be sent at time 25, and a fourth read command includes a time parameter specifying that data D is to be sent at time 40.

A respective read command may be sent at any suitable time prior to the time at which the data specified by that read command is to be sent by the target device 404. In one embodiment, the read commands are all sent prior to the transmission of data A specified by the first read command.

The target device 404 may receive the read commands and schedule the reads and transmissions in any suitable manner. According to the read commands, target device 404 sends data A at time 10, data B and time 20, data C at time 25, and data D at time 40. Thus, FIG. 4 depicts data A transmitted from the target device 404 to the consuming device 402, data B transmitted 10 time units after that, data C transmitted 5 time units after that, and data D transmitted 15 time units after that.

In some instances, a storage command with a time parameter may specify a flush operation. A flush command is a type of storage command used to direct data to be moved from one memory (e.g., a volatile write cache) into another memory (e.g., non-volatile memory). In one embodiment, the location in a flush command may be one or more namespaces and execution of the flush command may commit data and metadata associated with the specified namespace(s) to non-volatile media. For example, all writes completed prior to submission of the flush command may be committed to non-volatile media. The time parameter of the flush command may specify a time at which the flush operation is to be performed.

In some instances, a storage command with a time parameter may specify a storage removal operation, which may result in freeing up memory. For example, a storage command may specify deallocation, erasure, invalidation, or eviction of memory. A deallocation command (e.g., a TRIM or similar command) may notify a target device that the memory indicated by the location of the command is no longer needed. The target device may then mark the memory as invalid and may physically erase the memory at a later time (e.g., during a garbage collection process). An erase command may physically erase the memory indicated by the location (e.g., by writing different data to the memory or by otherwise removing the stored data from the location). In some embodiments, an erase command may be performed by writing all zeros to the specified location, all ones to the specified location, or a repeating pattern of ones and zeros (e.g., 0xaaaa, 0x5555, or 0xa5a5). An invalidate command may cause memory to be marked as invalid. An evict command may allow data (e.g., of a cache) to be overwritten by new data (in some instances, if the data is modified or “dirty”, the data may first be written to other memory, such as another cache or host memory).

The time parameter of a storage removal command may specify when the memory is to be removed (e.g., deallocated, erased, invalidated, or evicted). Knowledge that a processing event would occur in the future that would remove the need for certain data allows for a storage command specifying the deallocation, erasure, invalidation, or eviction and a time for the deallocation, erasure, invalidation, or eviction to be sent ahead of time. This may allow the data to be removed at a time known to both the requesting device and the target device. Such storage commands may also be staggered, such that removing a large memory range may happen in smaller chunks in a precise staggered fashion (e.g., multiple storage commands specifying precise times may be used or a single storage command that includes multiple time and address pairs could be used).

In various embodiments, a single storage command may specify multiple storage operations (e.g., a single opcode may correspond to multiple operations). For example, a storage command that specifies a read from a location or a write to a location, may also specify a removal (e.g., deallocation such as a TRIM operation, erasure, invalidation, or eviction) operation as well. As another example, a storage command that specifies a write to a location may also specify a flush operation.

The storage command that specifies multiple storage operations may also specify one or more time parameters. For example, the command may include respective time parameters for the individual storage operations, or a time parameter of one or more time parameters in the storage command may apply to multiple storage operations.

In the case of a combined write and removal command, the requesting device may send the data to a target device at a remote location and may inform the target device that it may remove the data at a particular time or after a specified amount of time has passed from an event (e.g., after the data is received by the target device or after the data is written by the device). Such a command may be especially useful in real-time use cases (e.g., data center AI/ML and data center processing for mobile applications). Such a command may be useful when data is to eventually be transferred to a processing unit and it is known that the data will not needed at a certain time in the future (either because it will have already been processed by the processing unit by that time or because the data would be late by that time and no longer useful, e.g., in a real-time application).

In some embodiments, a first operation of a storage command may load a memory space with data and a second operation of the storage command removes the data from the same memory space (e.g., by deallocating, erasing, invalidating, or evicting the data).

In some embodiments, storage commands with time parameters may be used to transfer data into ping and pong buffers in an efficient manner. In some embodiments, the ping and pong buffers may be a portion of a cache (e.g., an L3 cache) of a processing unit. In other embodiments, the ping and pong buffers may be a portion of an IPU, NIC, SmartNIC, FPGA, DPU, EPU, other processing unit, or memory. In some embodiments, a NIC may be able to transfer data directly into the ping and pong buffers, thus avoiding the power usage and latency associated with memory transfers to the host memory.

A specific example of such a flow will now be described, although features of this flow may be applied to any suitable embodiments. In this example, an IPU may know that a CPU will be consuming data from an SSD connected to the IPU (e.g., via PCIe, Ethernet, Ultra Ethernet, Infiniband, or other suitable network) on a large language AI model. The CPU may have a Data Direct I/O (DDIO) area (which the IPU can directly write data to) and ping and pong buffers inside the DDIO area. The IPU may also know that the CPU will start processing data at time X and will consume Y bytes (where Y may be any suitable integer) every 5 microseconds.

The IPU may then write Y bytes into the ping buffer before time X and direct that the Y bytes be flushed from the ping buffer (e.g., to a different memory, such as a cache) at time X+5 microseconds (e.g., a storage command may specify a write operation and a subsequent flush operation at time X+5). Although this example will be described using the term flush with respect to the ping and pong buffers, any suitable storage removal operation that frees up space in the ping buffer for a subsequent write operation may be used. For example, the data may be flushed to other memory (e.g., cache or host memory), evicted, marked as dirty, invalidated, physically erased, or deallocated. For example, the CPU memory may write to host memory when the data is written into the DDIO, and hence the data only needs to be invalidated during the flush. As another example, the CPU memory may not write to the host memory when data is written into the DDIO, and thus a TRIM or invalidation operation is sufficient for the flush as the data will no longer be used by AI algorithm, thus saving power. As another example, if the CPU dirtied any location in the ping or pong buffer, it should handle accordingly (e.g., the CPU should write through the cache), or a TRIM or invalidation operation would cause that data to be lost.

The IPU may subsequently write Y bytes into the pong buffer to be flushed at time X+10 microseconds (e.g., a storage command may specify a write operation and a subsequent flush operation at time X+10). This write may be issued at any time that will allow the write to complete before the data is needed (e.g., at X+5 microseconds).

At X+5 microseconds, the CPU flushes the data from the ping buffer (or performs other suitable operation, e.g., as described above, to free up the space in the ping buffer). At X+5.01 microseconds (or at a later time allowing the write to complete before the associated data is processed, e.g., at X+10 microseconds), the IPU writes Y bytes into the ping buffer to be flushed at time X+15 microseconds.

At X+10 microseconds, the CPU flushes the data from the pong buffer. At X+10.01 microseconds (or a later time allowing the write to complete before the associated data is processed, e.g., at X+15 microseconds), the IPU writes Y bytes into the pong buffer to be flushed at time X+20 microseconds.

At X+15 microseconds, the CPU flushes the data from the ping buffer. At X+15.01 microseconds (or a later time allowing the write to complete before the associated data is processed, e.g., at X+20 microseconds), IPU writes Y bytes into the ping buffer to be flushed at time X+25 microseconds. This process may repeat until the last transfer.

In this example, the IPU may preload the data from the SSD prior to the transfer window (the time over which the data is transferred to the ping and pong buffers). Any of the writes to a ping or pong buffer may take place after data from a plurality of packets has been coalesced by the IPU. In various iterations of the flow, the IPU can write to the respective buffer (ping or pong) any time between the flush of the data in the respective buffer and the time that the CPU will start retrieving the data from the buffer (e.g., after it finishes retrieving the data from the previous cycle from the other buffer).

In some instances, the CPU may send hints to the IPU to increase or decrease the 5 microseconds timing (e.g., if the data is being processed faster or slower than originally anticipated).

While the example above uses microseconds, other implementations could use nanoseconds, milliseconds, etc. It could also be a known epoch (e.g., a window of time or a period of time, in some instances the epoch could indicate the start of the next processing window).

In this example, the IPU could also issue a storage command (e.g., a combination read and then write zeros at time X+a”) to the SSD to erase the SSD read locations after the data has been processed, where “a” could be after the 5 microseconds or at some later time to confirm that the CPU has had enough time to process the data that is being erased. The write operation could be to the same physical addresses on the SSD, the SSD could send a confirmation of the write zeros, and the SSD could invalidate the location after the write zeros to allow for reusage of the memory area.

In various embodiments, the storage commands with time parameters may conform to the NVMe standard or the NVMeoF standard. For example, a storage command may be or comprise an NVMe flush, write, read, write uncorrectable, write zeroes, dataset management command, or sanitize command. In some examples, a storage command may combine operations of two or more of these NVMe commands.

In some embodiments, the opcode of a storage command with a time parameter may comprise a 1-byte opcode. In one embodiment, one bit of the opcode defines whether the storage command is a standard command or a vendor specific command, five bits of the opcode define the function of the command, and/or two bits of the opcode define the direction of data transfer. In a particular embodiment, the storage command may include a 1 value for the bit specifying whether the storage command is a vendor specific command.

The storage command may also comprise a namespace identifier (NSID) (e.g., expressed as 4 bytes) as at least a portion of the location specified by the storage command. In some embodiments, the NSID may immediately follow a 4-byte command field that includes the opcode (e.g., the opcode may be the least significant byte of the 4-byte command field), a fused operation field specifying (e.g., using 2 bits) whether the command is part of a fused operation, a two byte command identifier, and additional command information.

In various embodiments, the time parameter specified in a storage command is used to pace or limit NVMe operations. For example, the time parameter could be a rate (e.g., bytes/nanosecond, Kbytes per microsecond, etc.). In another example, the time parameter may be a time in which segments/portions of a transfer must occur. In another example, the time parameter could apply to the network connection, or the storage connection, or other portion of the transfer path(s) (e.g., internal transfers versus transfers across the data center, telecom, enterprise network, or other larger network).

In various embodiments, the storage commands may be or comprise Small Computer System Interface (SCSI) commands. For example, a SCSI read command may include a time parameter comprising a precise time. As another example, a SCSI write command may include a time parameter comprising a precise time.

In some embodiments, the storage commands may conform to the virtIO standard. For example, the storage command with at least one time parameter (e.g., a precise time) may be or comprise a virtio-blk command or a virtio-net command specifying a read operation or a write operation (optionally with a data wipe operation as well). In some embodiments, the time parameter (e.g., a precise time) is used to direct any of the following operations: fetch ring tail indexes, fetch avail ring, fetch descriptor rings, fetch network headers, generate door bells (e.g., originating from or sent to a CPU, GPU, accelerator, controller such as a memory controller or cache controller, other processing unit, etc.), scan queues (e.g., where the time parameter is a start time), send interrupts (e.g., MSIX interrupts) to a CPU, GPU, accelerator, or other component.

In various embodiments, NVMe over TCP could use a “time” in the TCP to help NVMe be more efficient. For example, in a time-aware TCP implementation, indications of times or delays may be sent to help resolve congestion in the network. For example, TCP packets for a transfer from the target device to the consuming device may start out at a very fast rate and then the transfer schedule of one or more packets may be adjusted based on an indication of time, delay, or rate in a TCP message from another node in the network (instead of dropping packets via a congestion window). The storage device may schedule data transfers based on the desired arrival time (e.g., NVMe transfers needed sooner may take up more of the available TCP bandwidth while later transfers could be delayed).

Similarly, in some embodiments, NVMe over RDMA could use a “time” in the RDMA to help NVMe be more efficient (e.g., in a manner similar to that described above with respect to TCP).

In various examples, a time aware storage protocol may be used to serve advertisements to mobile devices, assist a microservice, assist a real time application, assist an artificial intelligence application on a mobile or remote device, assist a database application to service a remote user, assist a database query, or assist an autonomous driving application, among other uses.

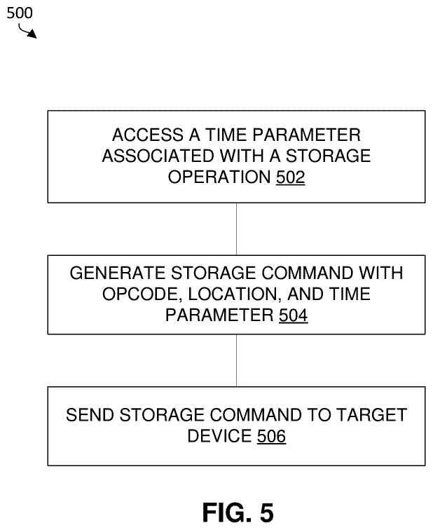

FIG. 5 illustrates a flow 500 for generating a storage command comprising a time parameter. The flow may be performed by any suitable component of a computing environment, such as a processing unit. At 502, a time parameter associated with a storage operation is accessed (e.g., the processing unit may determine the time parameter or may receive the time parameter from another processing unit or other component). The time parameter may be, for example, any of the time parameters described above or other suitable time parameter. At 504, a storage command with an opcode, location, and the time parameter 504 is generated. At 506, the storage command is sent to a target device.

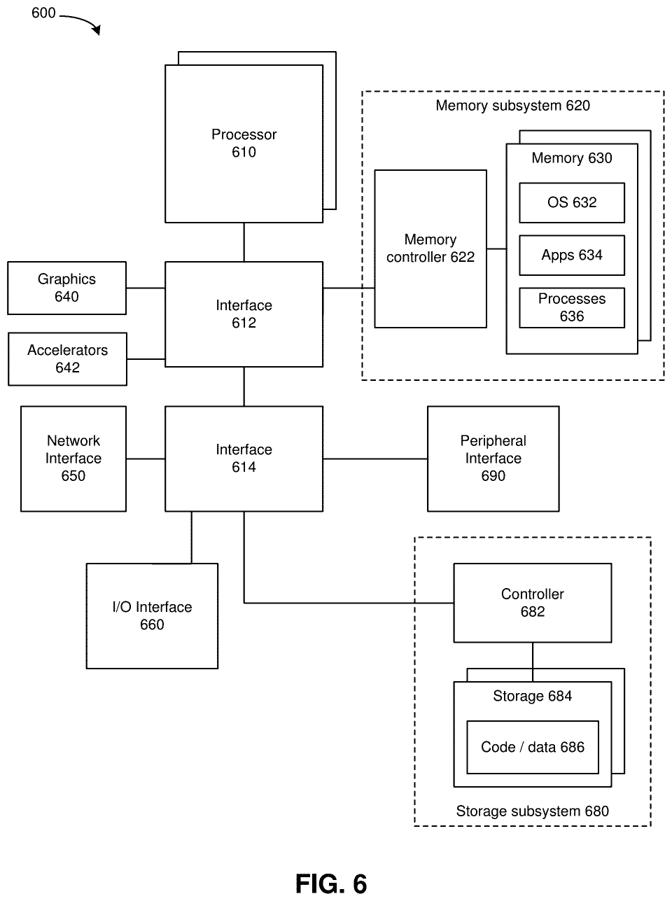

FIG. 6 depicts an example computing system that may be utilized in various embodiments. For example, any suitable depicted component of system 600 may function as a requesting device, consuming device, and/or target device with respect to storage commands comprising time parameters as described herein.

System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610. Memory subsystem 620 may include one or more caches, including, e.g., a DDIO area.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a CXL bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, an Ultra Ethernet interface, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. Various embodiments can be used in connection with network interface 650, processor 610, and memory subsystem 620.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614. In various embodiments, memory controller 622 and/or controller 682 may be time aware, that is, they may facilitate the movement of data based on time parameters (e.g., precise time).

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disk may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

Logic may be used to implement any of the flows described or functionality of the various systems or components described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

The embodiments of methods, hardware, software, firmware or code set forth above may be implemented via instructions or code stored on a machine-accessible, machine readable, computer accessible, or computer readable medium which are executable by a processing element. A machine-accessible/readable medium includes any mechanism that provides (e.g., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Various examples of the embodiments described herein are as follows:

Example 1 includes an apparatus comprising first circuitry to determine a time parameter associated with a storage operation; and second circuitry to generate a storage command, the storage command including the time parameter, a location for the storage operation, and an opcode specifying the storage operation.

Example 2 includes the subject matter of Example 1, and wherein the storage command is a Non-Volatile Memory Express (NVMe) command.

Example 3 includes the subject matter of any of Examples 1 and 2, and wherein the location comprises an address of a storage drive.

Example 4 includes the subject matter of any of Examples 1-3, and wherein the time parameter comprises a time of execution of the storage operation.

Example 5 includes the subject matter of any of Examples 1-4, and wherein the time is a precise time that is synchronized between the apparatus and a recipient of the storage command.

Example 6 includes the subject matter of any of Examples 1-5, and wherein the time parameter comprises a data transmission rate.

Example 7 includes the subject matter of any of Examples 1-6, and wherein the time parameter comprises a data consumption rate.

Example 8 includes the subject matter of any of Examples 1-7, and wherein the opcode further specifies a second storage operation.

Example 9 includes the subject matter of any of Examples 1-8, and wherein the storage command further includes a second time parameter associated with the second storage operation.

Example 10 includes the subject matter of any of Examples 1-9, and wherein the storage operation is a write data operation.

Example 11 includes the subject matter of any of Examples 1-10, and wherein the storage operation is a read data operation.

Example 12 includes the subject matter of any of Examples 1-11, and wherein the storage operation is a data removal operation.

Example 13 includes the subject matter of any of Examples 1-12, and further including a processor unit comprising the second circuitry.

Example 14 includes the subject matter of any of Examples 1-13, and further including one or more of a battery communicatively coupled to the processor unit, a display communicatively coupled to the processor unit, or a network interface communicatively coupled to the processor unit.

Example 15 includes at least one non-transitory machine readable storage medium having instructions stored thereon, the instructions when executed by a machine to cause the machine to determine a time parameter associated with a storage operation; and generate a storage command, the storage command including the time parameter, a location for the storage operation, and an opcode specifying the storage operation.

Example 16 includes the subject matter of any of Examples 1-15, and wherein the storage command is a Non-Volatile Memory Express (NVMe) command.

Example 17 includes the subject matter of any of Examples 1-16, and wherein the location comprises an address of a storage drive.

Example 18 includes the subject matter of any of Examples 1-17, and wherein the time parameter comprises a time of execution of the storage operation.

Example 19 includes the subject matter of any of Examples 1-18, and wherein the time is a precise time that is synchronized between the machine and a recipient of the storage command.

Example 20 includes the subject matter of any of Examples 1-19, and wherein the time parameter comprises a data transmission rate.

Example 21 includes the subject matter of any of Examples 1-20, and wherein the time parameter comprises a data consumption rate.

Example 22 includes the subject matter of any of Examples 1-21, and wherein the opcode further specifies a second storage operation.

Example 23 includes the subject matter of any of Examples 1-22, and wherein the storage command further includes a second time parameter associated with the second storage operation.

Example 24 includes the subject matter of any of Examples 1-23, and wherein the storage operation is a write data operation.

Example 25 includes the subject matter of any of Examples 1-24, and wherein the storage operation is a read data operation.

Example 26 includes the subject matter of any of Examples 1-25, and wherein the storage operation is a data removal operation.

Example 27 includes a method comprising determining a time parameter associated with a storage operation; and generating a storage command, the storage command including the time parameter, a location for the storage operation, and an opcode specifying the storage operation.

Example 28 includes the subject matter of Example 27, and wherein the storage command is a Non-Volatile Memory Express (NVMe) command.

Example 29 includes the subject matter of any of Examples 27 and 28, and wherein the location comprises an address of a storage drive.

Example 30 includes the subject matter of any of Examples 27-29, and wherein the time parameter comprises a time of execution of the storage operation.

Example 31 includes the subject matter of any of Examples 27-30, and wherein the time is a precise time that is synchronized between the machine and a recipient of the storage command.

Example 32 includes the subject matter of any of Examples 27-31, and wherein the time parameter comprises a data transmission rate.

Example 33 includes the subject matter of any of Examples 27-32, and wherein the time parameter comprises a data consumption rate.

Example 34 includes the subject matter of any of Examples 27-33, and wherein the opcode further specifies a second storage operation.

Example 35 includes the subject matter of any of Examples 27-34, and wherein the storage command further includes a second time parameter associated with the second storage operation.

Example 36 includes the subject matter of any of Examples 27-35, and wherein the storage operation is a write data operation.

Example 37 includes the subject matter of any of Examples 27-36, and wherein the storage operation is a read data operation.

Example 38 includes the subject matter of any of Examples 27-37, and wherein the storage operation is a data removal operation.

Example 39 includes a system comprising means to determine a time parameter associated with a storage operation; and means to generate a storage command, the storage command including the time parameter, a location for the storage operation, and an opcode specifying the storage operation.

Example 40 includes an apparatus comprising first circuitry to receive a storage command, the storage command comprising an opcode specifying a storage operation, a time parameter associated with the storage operation, and a location associated with the storage operation; and second circuitry to perform the storage operation in accordance with the time parameter.

Example 41 includes the subject matter of Example 40, and wherein the storage command is a Non-Volatile Memory Express (NVMe) command.

Example 42 includes the subject matter of any of Examples 40 and 41, and wherein the location comprises an address of a storage drive.

Example 43 includes the subject matter of any of Examples 40-42, and wherein the time parameter comprises a time of execution of the storage operation.

Example 44 includes the subject matter of any of Examples 40-43, and wherein the time is a precise time that is synchronized between the apparatus and a recipient of the storage command.

Example 45 includes the subject matter of any of Examples 40-44, and wherein the time parameter comprises a data transmission rate.

Example 46 includes the subject matter of any of Examples 40-45, and wherein the time parameter comprises a data consumption rate.

Example 47 includes the subject matter of any of Examples 40-46, and wherein the opcode further specifies a second storage operation.

Example 48 includes the subject matter of any of Examples 40-47, and wherein the storage command further includes a second time parameter associated with the second storage operation.

Example 49 includes the subject matter of any of Examples 40-48, and wherein the storage operation is a write data operation.

Example 50 includes the subject matter of any of Examples 40-49, and wherein the storage operation is a read data operation.

Example 51 includes the subject matter of any of Examples 40-50, and wherein the storage operation is a data removal operation.

Example 52 includes the subject matter of any of Examples 40-51, and further including a processor unit.

Example 53 includes the subject matter of any of Examples 40-52, and further including one or more of a battery communicatively coupled to the processor unit, a display communicatively coupled to the processor unit, or a network interface communicatively coupled to the processor unit.

Example 54 includes at least one non-transitory machine readable storage medium having instructions stored thereon, the instructions when executed by a machine to cause the machine to receive a storage command, the storage command comprising an opcode specifying a storage operation, a time parameter associated with the storage operation, and a location associated with the storage operation; and perform the storage operation in accordance with the time parameter.

Example 55 includes the subject matter of any of Examples 40-54, and wherein the storage command is a Non-Volatile Memory Express (NVMe) command.

Example 56 includes the subject matter of any of Examples 40-55, and wherein the location comprises an address of a storage drive.

Example 57 includes the subject matter of any of Examples 40-56, and wherein the time parameter comprises a time of execution of the storage operation.

Example 58 includes the subject matter of any of Examples 40-57, and wherein the time is a precise time that is synchronized between the apparatus and a recipient of the storage command.

Example 59 includes the subject matter of any of Examples 40-58, and wherein the time parameter comprises a data transmission rate.

Example 60 includes the subject matter of any of Examples 40-59, and wherein the time parameter comprises a data consumption rate.

Example 61 includes the subject matter of any of Examples 40-60, and wherein the opcode further specifies a second storage operation.

Example 62 includes the subject matter of any of Examples 40-61, and wherein the storage command further includes a second time parameter associated with the second storage operation.

Example 63 includes the subject matter of any of Examples 40-62, and wherein the storage operation is a write data operation.

Example 64 includes the subject matter of any of Examples 40-63, and wherein the storage operation is a read data operation.

Example 65 includes the subject matter of any of Examples 40-64, and wherein the storage operation is a data removal operation.

Example 66 includes a method comprising receiving a storage command, the storage command comprising an opcode specifying a storage operation, a time parameter associated with the storage operation, and a location associated with the storage operation; and performing the storage operation in accordance with the time parameter.

Example 67 includes the subject matter of Example 66, and wherein the storage command is a Non-Volatile Memory Express (NVMe) command.

Example 68 includes the subject matter of any of Examples 66 and 67, and wherein the location comprises an address of a storage drive.

Example 69 includes the subject matter of any of Examples 66-68, and wherein the time parameter comprises a time of execution of the storage operation.

Example 70 includes the subject matter of any of Examples 66-69, and wherein the time is a precise time that is synchronized between the apparatus and a recipient of the storage command.

Example 71 includes the subject matter of any of Examples 66-70, and wherein the time parameter comprises a data transmission rate.

Example 72 includes the subject matter of any of Examples 66-71, and wherein the time parameter comprises a data consumption rate.

Example 73 includes the subject matter of any of Examples 66-72, and wherein the opcode further specifies a second storage operation.

Example 74 includes the subject matter of any of Examples 66-73, and wherein the storage command further includes a second time parameter associated with the second storage operation.

Example 75 includes the subject matter of any of Examples 66-74, and wherein the storage operation is a write data operation.

Example 76 includes the subject matter of any of Examples 66-75, and wherein the storage operation is a read data operation.

Example 77 includes the subject matter of any of Examples 66-76, and wherein the storage operation is a data removal operation.

Example 78 includes a system comprising means to receive a storage command, the storage command comprising an opcode specifying a storage operation, a time parameter associated with the storage operation, and a location associated with the storage operation; and means to perform the storage operation in accordance with the time parameter.

Example 79 includes one or more non-transitory computer-readable media with code stored thereon, wherein the code is executable to cause a processor unit to perform any one or more of the operations of Examples 27-37 and 66-78.

What is claimed is:

1. An apparatus comprising:
first circuitry to access a time parameter associated with a storage operation; and
second circuitry to generate a storage command, the storage command including the time parameter, a location for the storage operation, and an opcode specifying the storage operation.

2. The apparatus of claim 1, wherein the storage command is an Non-Volatile Memory Express (NVMe) command.

3. The apparatus of claim 1, wherein the location comprises an address of a storage drive.

4. The apparatus of claim 1, wherein the time parameter comprises a time of execution of the storage operation.

5. The apparatus of claim 4, wherein the time is a precise time that is synchronized between the apparatus and a recipient of the storage command.

6. The apparatus of claim 1, wherein the time parameter comprises a data transmission rate.

7. The apparatus of claim 1, wherein the time parameter comprises a data consumption rate.

8. The apparatus of claim 1, wherein the opcode further specifies a second storage operation.

9. The apparatus of claim 8, the storage command further including a second time parameter associated with the second storage operation.

10. The apparatus of claim 1, wherein the storage operation is a write data operation.

11. The apparatus of claim 1, wherein the storage operation is a read data operation.

12. The apparatus of claim 1, wherein the storage operation is a data removal operation.

13. The apparatus of claim 1, further comprising a processor unit comprising the second circuitry.

14. The apparatus of claim 13, further comprising one or more of: a battery communicatively coupled to the processor unit, a display communicatively coupled to the processor unit, or a network interface communicatively coupled to the processor unit.

15. An apparatus comprising:
first circuitry to receive a storage command, the storage command comprising an opcode specifying a storage operation, a time parameter associated with the storage operation, and a location associated with the storage operation; and
second circuitry to perform the storage operation in accordance with the time parameter.

16. The apparatus of claim 15, wherein the storage operation is a data removal operation.

17. The apparatus of claim 15, wherein the opcode further specifies a second storage operation.

18. One or more non-transitory computer-readable media with code stored thereon, wherein the code is executable to cause a processor unit to:
access a time parameter associated with a storage operation; and
generate a storage command, the storage command including the time parameter, a location for the storage operation, and an opcode specifying the storage operation.

19. The media of claim 18, wherein the storage operation is a data removal operation.

20. The media of claim 18, wherein the opcode further specifies a second storage operation.
